(19) United States
(12) Patent Application Publication
(10) Pub. No.: US 2023/0262803 A1
(43) Pub. Date: Aug. 17, 2023

(54) METHOD AND APPARATUS FOR WIRELESS COMMUNICATION OF LOW LATENCY DATA BETWEEN MULTILINK DEVICES

(71) Applicant: CANON KABUSHIKI KAISHA, Tokyo (JP)

(72) Inventors: Pascal VIGER, JANZE (FR); Stéphane BARON, LE RHEU (FR); Patrice NEZOU, LIFFRE (FR)

(21) Appl. No.: 18/014,986

(22) PCT Filed: Jul. 8, 2021
(86) PCT No.: PCT/EP2021/069042

§ 371 Date: Jan. 6, 2023

(30) Foreign Application Priority Data
Jul. 10, 2020 (GB) 2010693.6

(51) Int. Cl. H04W 76/15; H04L 5/00

(52) U.S. Cl. CPC H04W 76/15; H04L 5/0053

(57) ABSTRACT

In a multilink system, block acknowledgment is performed at TID level. It is commonly accepted that acknowledgment policy refrains low latency delivery. However, it is often that traffic streams combine low-latency data and data requiring a high level of reliability. A need exists to facilitate the transmission of low-latency data units of a TID when a multilink operation, such as in 802.11be, is implemented with an acknowledgment policy. One specific link from amongst the multiple links may be dedicated to low latency data for which the originator and the recipient no longer take into account the acknowledgment. It turns that the originator can remove the low latency data from its transmit buffer immediately after transmission, while the recipient can deliver these data to the upper layer without waiting for the good reception of all preceding data, according to a sequence numbering. Low-latency services are consequently improved.

### FIELD OF THE INVENTION

The present invention generally relates to wireless communications.

### BACKGROUND OF THE INVENTION

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

The 802.11 family of standards adopted by the Institute of Electrical and Electronics Engineers (IEEE-RTM) provides a great number of mechanisms for wireless communications between stations.

As a successor of the 802.11ax standard-draft version 6.0 (D6.0) of November 2019—, the 802.11be standard, namely EHT standing for “Extremely High Throughput”, is being considering a feature called multi-link operation (MLO).

To implement the MLO feature, a single device, namely a multilink, ML, device, implements a ML logical entity made of a plurality of stations. The stations can use 802.11 mechanisms to communicate with stations of another ML device over respective communication links, thereby establishing a multilink communication session to exchange data units (e.g. MPDUs).

Traffic data units (MPDUs) can then be exchanged between the ML devices over the multiple links so established. The ML devices store the exchanged data units in respective communication buffers, a so-called “transmit buffer” for the originator ML device and a so-called “reordering buffer” for the recipient ML device.

Advantageously, the MLO feature increases the peak/average throughput of the ML devices.

However, it is not adapted to bandwidth-demanding and low-latency communication services between the ML devices (e.g. video-based services such as gaming, virtual reality, streaming applications conveyed over the same traffic stream) that also include data (e.g. control data) the transmission of which still needs to be kept reliable. This is because all the communications over the multiple links share a common delivery policy, such as an acknowledgment policy (i.e. an acknowledgment scheme acknowledging correct reception of the data units) and sequence numbering.

In particular, the management of the communication buffers while the data units are being exchanged follows a management rule that is based on the correct reception of the data units by the recipient ML device.

At the originator, the data units including the low-latency data remain in the transmit buffer as long as no acknowledgment of correct receipt is received from the recipient ML device. It means that freeing space in the transmit buffer to transmit new data units is delayed, which may be prejudicial to low-latency services.

Similarly, at the recipient, the data units including the low-latency data are not delivered to an upper layer (application layer) and remain in the reordering buffer as long as the preceding data units according to the sequence numbering used by the originator have not been correctly received. It turns that the low-latency data cannot reach the upper layer, degrading the low-latency service.

Consequently, it is desirable to design more efficient multilink communication mechanisms adapted to low-latency data.

### SUMMARY OF INVENTION

It is a broad objective of the present invention to overcome some of the foregoing concerns.

It is proposed that the stored data units that are exchanged over one (or more) specific link of the multiple links are managed in the communication buffer regardless of the management rule specified above.

In this respect, a communication method, at an originator multilink, ML, device storing data units in a transmit buffer, comprises:

establishing a multilink communication session with a recipient ML device to transmit the stored data units over multiple links based on an acknowledgment scheme acknowledging correct reception of the data units,

transmitting the data units over the multiple links, and

removing stored data units from the transmit buffer based on corresponding data unit acknowledgments received from the recipient ML device,

wherein the stored data units transmitted over one specific link of the multiple links are removed from the transmit buffer regardless of any respective data unit acknowledgment from the recipient ML device.

Correspondingly, a communication method, at a recipient multilink, ML, device, comprises:

establishing a multilink communication session with an originator ML device to receive data over multiple links,

receiving data units over the multiple links, storing the received data units in a reordering buffer, and acknowledging the received data units to the originator ML device, and

delivering stored data units to an upper layer of the recipient ML device based on a sequence ordering of the data units,

wherein the stored data units transmitted over one specific link of the multiple links are delivered to the upper layer regardless of the sequence ordering. In particular, they can be immediately (i.e. upon reception) delivered to the upper layer.

In other words, the management of the communication buffer, in particular to free space therein or to deliver data units to the upper layer depends on which link (of the multiple links) the data units are transmitted. It turns that one (or more) link may be easily dedicated to low-latency data without the known constraints of buffer management, in particular without the need of acknowledgment.

The management may mean updating the buffer such as removing (i.e. deleting, suppressing, clearing or discarding) the data units from the communication buffer (at both originator and recipient ML device sides), and/or mean delivering the data units to an upper layer (for instance at the recipient ML device side).

In practice, direct removal of the low-latency data units (transmitted over the specific link) can be envisioned regardless of whether a corresponding acknowledgment (of correct receipt) is received from the recipient ML device. New data units can then populate the transmit buffer and be sent earlier. Data units requiring reliability can be transmitted over other links of the multiple links, still keeping the conventional management rule for them to be retransmitted if no acknowledgment is received.

Similarly, direct delivery of the low-latency data units to the upper layer can be performed at the recipient side, without waiting for the correct reception of all the preceding data units according to the sequence numbering. Quality of low-latency services is therefore improved.

Correlatively, the invention also provides a wireless communication device comprising at least one microprocessor configured for carrying out the steps of any of the above methods.

Optional features of embodiments of the invention are defined in the appended claims. Some of these features are explained here below with reference to a method, while they can be transposed into device features.

In some embodiments, the data units transmitted (or received) over the multiple links have the same transport identifier, TID. Indeed, the acknowledgment scheme or policy is usually defined at a TID level. It means that a (e.g. low-latency) subpart of the TID (traffic stream) is exchanged over the specific link or links for which acknowledgments are useless, while the other subpart is exchanged over one or more other links of the multiple links.

In some embodiments, the stored data units that are transmitted over one link separate from the specific link are removed (or delivered to the upper layer) from the transmit buffer based on corresponding data unit acknowledgments received from the recipient ML device. This is usually dedicated to the data requiring reliability since acknowledgments thereof are needed. Similarly, the stored data units that are received over one link separate from the specific link are delivered to the upper layer based on the sequence ordering.

In particular, the data units transmitted (or received) over the specific link are low-latency data compared to the data units transmitted (or received) over the separate link (which require more reliability).

In some embodiments, the removed data units are removed from the transmit buffer upon transmission over the specific link. This approach frees the transmit buffer as earlier as possible. Quality of low-latency services may then be substantially improved.

According to a variant, the method further comprises locally building an acknowledgment scoreboard upon transmitting stored data units over the specific link, wherein the acknowledgment scoreboard acknowledges the transmitted data units and is used to update the transmit buffer accordingly (e.g. remove these data units from the buffer).

In this variant, an acknowledgment record (of a block acknowledgment frame) received from the recipient ML device may be modified based on the acknowledgment scoreboard. In that case, the acknowledgment record and the acknowledgment scoreboard relate to the same data units, in order to have a consistent modification. The use of start sequence numbers (SSN) may help determining that the record and the local scoreboard indeed relate to the same data units.

Also, a bitmap of the received acknowledgment record may be XORed with the acknowledgment scoreboard. This approach advantageously does not modify the application of the management rule to the communication buffer because the acknowledgment bitmap is still used to determine which data units to remove. Thanks to the XORed, the data units transmitted over the specific link are removed from the buffer regardless of whether they are acknowledged or not by the recipient.

In particular, the built acknowledgement scoreboard may be locally transmitted to a buffer updating module in a block acknowledgment frame format. This ensures a conventional buffer updating module can still be used.

In some embodiments, a stored data unit that is transmitted over one link separate from the specific link is removed from the transmit buffer upon receiving a respective data unit acknowledgment from the recipient ML device. Conventional buffer management is kept for those data units conveyed over the separate link (or links).

According to an optional feature at the recipient, the stored data units that are received over the specific link are delivered to the upper layer upon reception thereof. This provides the (low latency) data units as fast as possible to upper layers.

In some embodiments, the stored data units that are received over one link separate from the specific link are delivered to the upper layer depending on a sequence ordering of correctly received data units. Conventional buffer management (here to deliver stored data units) is kept for those data units conveyed over the separate link (or links).

Another aspect of the invention relates to a non-transitory computer-readable medium storing a program which, when executed by a microprocessor or computer system in a wireless device, causes the wireless device to perform any method as defined above.

At least parts of the methods according to the invention may be computer implemented. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer readable code for provision to a programmable apparatus on any suitable carrier medium. A tangible carrier medium may comprise a storage medium such as a hard disk drive, a magnetic tape device or a solid state memory device and the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Embodiments of the invention will now be described, by way of example only, and with reference to the following drawings in which:

FIG. 1 illustrates an example of a multi-link arrangement in accordance with 802.11be;

FIG. 2 illustrates a typical 802.11 network environment in which stations of a ML device operate;

FIG. 3 illustrates an exemplary 802.11be multi-link reference model for a ML device;

FIG. 4 illustrates a detailed architecture of ML devices exchanging data in a multilink communication session with acknowledgment policy;

FIG. 5 illustrates a detailed architecture of ML devices according to embodiments of the invention;

FIG. 6 illustrates an alternative detailed architecture of ML devices according to embodiments of the invention;

FIG. 7 illustrates, using a flowchart, exemplary steps to manage a Tx scoreboard in the architecture of FIG. 6;

FIG. 8 illustrates another alternative detailed architecture of ML devices according to embodiments of the invention;

FIG. 9 illustrates, using a flowchart, exemplary steps to perform a modification of a BA frame in the architecture of FIG. 8;

FIG. 10 illustrates an exemplary timeline of a communication exchange according to embodiments of present invention;

FIG. 11 shows a schematic representation a communication device in accordance with embodiments of the present invention; and

FIG. 12 shows a schematic representation of a wireless communication device in accordance with embodiments of the present invention.

### DETAILED DESCRIPTION OF EMBODIMENTS

The techniques described herein may be used for various broadband wireless communication systems, including communication systems that are based on an orthogonal multiplexing scheme. Examples of such communication systems include Spatial Division Multiple Access (SDMA) system, Time Division Multiple Access (TDMA) system, Orthogonal Frequency Division Multiple Access (OFDMA) system, and Single-Carrier Frequency Division Multiple Access (SC-FDMA) system. An SDMA system may utilize sufficiently different directions to simultaneously transmit data belonging to multiple user terminals, i.e. wireless devices or stations. A TDMA system may allow multiple user terminals to share the same frequency channel by dividing the transmission signal into different time slots or resource units, each time slot being assigned to different user terminal. An OFDMA system utilizes orthogonal frequency division multiplexing (OFDM), which is a modulation technique that partitions the overall system bandwidth into multiple orthogonal sub-carriers or resource units. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers.

The teachings herein may be incorporated into (e.g., implemented within or performed by) a variety of apparatuses (e.g., stations). In some aspects, a wireless device or station implemented in accordance with the teachings herein may comprise an access point (so-called AP) or not (so-called non-AP station or STA).

An AP may comprise, be implemented as, or known as a Node B, Radio Network Controller (“RNC”), evolved Node B (eNB), 5G Next generation base station (gNB), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

A non-AP station may comprise, be implemented as, or known as a subscriber station, a subscriber unit, a mobile station (MS), a remote station, a remote terminal, a user terminal (UT), a user agent, a user device, user equipment (UE), a user station, or some other terminology. In some implementations, a STA may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the non-AP station may be a wireless node. Such wireless node may provide, for example, connectivity for or to a network (e.g., a wide area network such as the Internet or a cellular network) via a wired or wireless communication link.

The communication systems may provide wireless communications between the stations using standards of the IEEE 802.11 family.

As a successor of the 802.11ax standard-draft version 6.0 (D6.0) of November 2019—, the 802.11be standard, namely EHT standing for “Extremely High Throughput”, is being considering a feature called multi-link operation (MLO). The 802.11 baseline is defined in the IEEE P802.11-REVmd document.

To implement the MLO feature, a single device, namely a multilink, ML, device, implements a ML logical entity. In this context, “multilink device”, “ML device” (MLD), “multilink logical entity”, “ML logical entity” (MLE), “multilink set” and “ML set” are synonyms to designate such device.

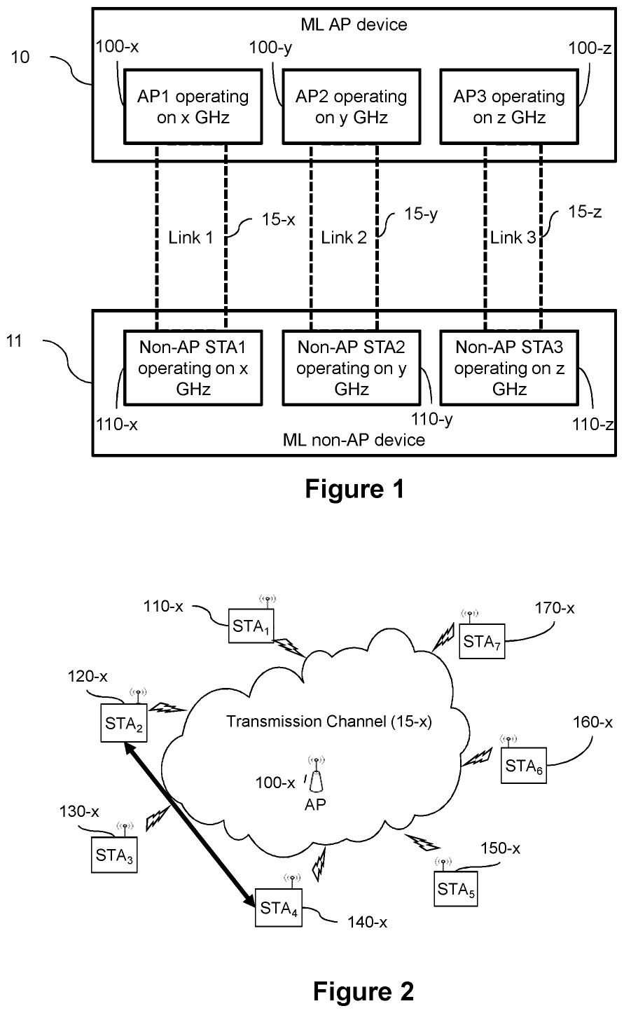

As shown in FIG. 1 illustrating an example of two ML devices establishing a multilink communication session to exchange data units, in accordance with 802.11be, a ML logical entity 10, 11 is a logical entity that has one or more affiliated stations 100/110-x, 100/110-y, 100/110-z. The ML logical entity has one MAC data service interface and primitives to the Logical Link Control (LLC) and a single address associated with the interface, which can be used to communicate on the distribution system medium (DSM).

A station 100/110-x, 100/110-y, 100/110-z is a logical entity that is a singly addressable instance of a medium access control (MAC) and physical layer (PHY) interface to the wireless medium.

A link 15-x, 15-y, 15-z is a physical path consisting of exactly one traversal of the wireless medium (VVM) that is usable to transfer MAC service data units (MSDUs) between two stations (STAs). As readily apparent from the Figure, station 100-x and station 110-x establish a communication channel one with the other, shown as link 1 (15-x); station 100-y and station 110-y establish a communication one with the other, shown as link 2 (15-Y); and station 100-z and station 110-z establish a communication one with the other, shown as link 3 (15-z). The terminology “link” is used to better align with the IEEE P802.1AX-Rev/D1.1 Bridges and Bridged Networks Link Aggregation, where each MAC and PHY interface is viewed as a link.

Preferably, the links established for a ML device are considered as fully independent, meaning that the channel access procedure (to the communication medium) and the communication are performed independently on each link. There is no synchronization between the links: a per-link backoff procedure (i.e. with own EDCA parameters, e.g. CW_min, CW_max, AIFS, etc.) to be granted access to the respective wireless medium is performed for each link.

The ML devices of the Figure therefore establish multiple links 15-x, 15-y, 15-z through their multiple affiliated stations, thereby establishing a multilink communication session.

Different links may have different data rates (e.g. due to different bandwidths, number of antennas, etc.).

A ML device or logical entity may thus be seen as a collection of two or more stations, each station operating on a specific link (frequency band) and comes with its own link specific PHY and lower MAC layer. The stations forming the same ML logical entity may be partly or all collocated within the same device or geographically dispersed.

The multiple links may be used to communicate different types of information (each over a specific link).

In a system supporting multi-link aggregation, some of the traffic associated with a single station may be transmitted across multiple parallel communication links, thereby increasing network capacity and maximizing utilization of available resources. The terms “traffic” and/or “traffic stream(s)” as used herein, are defined as a data flow and/or stream between wireless devices.

A ML device or logical entity may be a ML AP device 10, in which case each affiliated station 100-x, 100-y, 100-z is an AP in its wireless network. A ML device or logical entity may be a ML non-AP device 11, in which case each affiliated station 110-x, 110-y, 110-z is a non-AP in its wireless network.

The APs 100-x, 100-y, 100-z and/or the non-AP stations 110-x, 110-y, 110-z operate in accordance with one or more of the IEEE 802.11 standards (a/b/g/n/ac/ad/af/ah/aj/ay/ax/be—also known under the Wifi designation [RTM]) and other wireless communication standards.

The stations 100-x, 100-y, 100-z (and thus corresponding stations 110-x, 110-y, 110-z) may operate in frequency bands that are different one from the other as shown in the example of FIG. 1. For instance, x=2.4 GHz, y=5 GHz, z=6 GHz.

Alternatively, two or more of the stations may use the same frequency band. For instance, y=z=6 GHz.

Although FIG. 1 shows a ML AP device and a ML non-AP device establishing a ML communication session, two non-AP devices may also establish such a ML communication session. Similarly, although ML devices made of three stations are shown, ML devices with another number of stations may be contemplated with the same teachings. In addition, ML devices may have different numbers of affiliated stations.

FIG. 2 illustrates an exemplary communication system in which two stations of the two ML devices 10, 11 can establish a communication link. Although FIG. 2 shows a wireless network for the “-x” stations, similar wireless networks may be implemented for the other stations of the ML devices.

In the shown communication system, several communication stations 100/170-x exchange data frames over a radio transmission channel 15-x of a wireless local area network (WLAN), under the management of a central station, or access point (AP) 100-x, also seen as a station of the network. The radio transmission channel 15-x is defined by an operating frequency band constituted by a single channel or a plurality of channels forming a composite channel. The AP 100-x and the associated non-AP stations 110/170-x may represent a basic service set (BSS) or an extended service set (ESS). Two non-AP stations 110/170-x may also communicate directly via a direct wireless link regardless of whether both non-AP stations belong to the same BSS or ESS. In a variant, direct communications between non-AP stations can be implemented without the use of the access point (known as an Ad-hoc mode).

Each non-AP station 110/170-x registers to the AP 100-x during an association procedure where the AP assigns a specific Association IDentifier (AID) to the requesting non-AP station. For example, the AID is a 16-bit value uniquely identifying the non-AP station.

The stations 100/170-x (including the AP) may compete one against another using EDCA (Enhanced Distributed Channel Access) contention, to access the wireless medium 15-x in order to be granted a transmission opportunity (TXOP) and then transmit (single-user, SU) data frames. The stations may also use a multi-user (MU) scheme in which a single station, usually the AP 100-x, is allowed to schedule a MU transmission, i.e. multiple simultaneous transmissions to or from other stations, in the wireless network. One implementation of such a MU scheme has been for example adopted in IEEE 802.11ax amendment standard, as the Multi-User Uplink and Downlink OFDMA (MU UL and DL OFDMA) procedures. Thanks to the MU feature, a non-AP station has the opportunity to gain access to the wireless medium via two access schemes: the MU scheme and the conventional Enhanced Distributed Channel Access—EDCA (Single User) scheme.

During the MU DL transmission on the granted communication channel, the AP performs multiple simultaneous elementary transmissions, over so-called resource units (RUs), to various non-AP stations. As an example, the resource units split the communication channel of the wireless network in the frequency domain, based for instance on Orthogonal Frequency Division Multiple Access (OFDMA) technique. The assignment of the RUs to the non-AP stations is signaled at the beginning of the MU Downlink frame, by providing an association identifier (AID) of a non-AP station (individually obtained by each station during its association procedure with the AP) for each RU defined in the transmission opportunity.

During the MU UL transmission, various non-AP stations can simultaneously transmit data to the AP over the resource units forming the communication channel. To control the MU UL transmission by the non-AP stations, the AP previously sends a control frame, known as a Trigger Frame (TF). The Trigger Frame allocates the resource units to the non-AP stations of the same BSS, using 16-bit Association IDentifiers (AIDs) assigned to them upon registration to the AP and/or using reserved AIDs designating a group of non-AP stations. The TF also defines the start of the MU UL transmission by the non-AP stations as well as the length thereof.

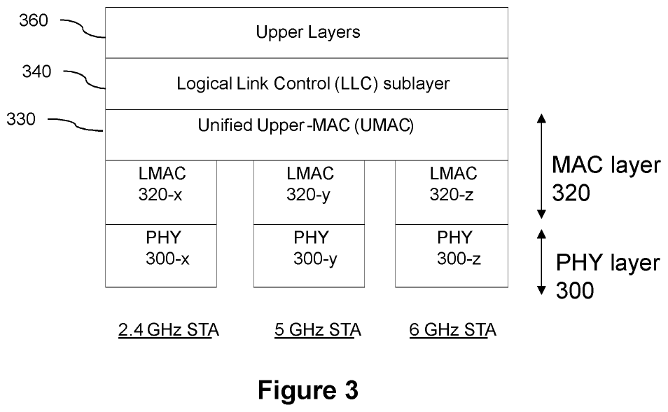

FIG. 3 illustrates an exemplary 802.11be multi-link reference model for a ML device (either ML AP device or ML non-AP device), be it an originator ML device (i.e. device transmitting data) or a recipient ML device (i.e. device receiving the data from the originator ML device).

The ML device comprises a PHY layer 300, a MAC layer 320, a logical Link Control (LLC) sublayer 340 and upper layers 360.

Upper layers may include applications that generate traffic data for transmission by the MAC and PHY layers over the multiple links or that use traffic data received by the MAC and PHY layers over the multiple links.

The traffic data are provided as a sequence of data frames, known as MSDUs (MAC service data units). Each MSDU contains an 802.1 D priority or User priority (UP) or traffic type (TID—standing for Traffic Identifier) taking values in the range 0-7. In 802.11, this value is used to assign the MSDUs to access categories (ACs), according to a predefined UP-to-AC mapping rule.

Four ACs are conventionally defined in EDCA. AC3 and AC2 are usually reserved for real-time applications (e.g., voice or video transmission). They have, respectively, the highest priority and the penultimate highest priority. AC1 and AC0 are reserved for best effort and background traffic. They have, respectively, the penultimate lowest priority and the lowest priority.

Each data unit, MSDU, arriving at the MAC layer 320 from an upper layer (e.g. Link layer) with a type of traffic (TID) priority is mapped into one of the ACs according to the mapping rule and the data unit is then stored in a buffer corresponding to the mapped AC.

When an access to the wireless medium is granted, data units are transmitted to the physical layer 300 for transmission onto the wireless communication network.

In the case of ML devices, PHY layer 300 comprises multiple PHY blocks 300-x, 300-y, 300-z dedicated for respective multiple links 15-x, 15-y, 15-z.

MAC layer 320 also comprises multiple blocks 320-x, 320-y, 320-z for respective multiple links 15-x, 15-y, 15-z.

MAC layer 320 also comprises a Unified Upper-MAC (UMAC) 330. UMAC 330 is responsible for link-agnostic MAC procedures such as sequence number assignments, MPDU encryption/decryption, block ack scoreboarding, etc. It offers a UMAC interface with the link-specific blocks 320-x, 320-y, 320-z (forming lower MAC sublayers, therefore referred to as LMAC) and provides a UMAC Service Access Point (SAP) to the LLC and upper layers 340, 360.

The Figure shows three LMAC and PHY blocks. Of course another number of blocks may be contemplated depending on the number of links the ML device can manage.

As an example, LMAC layer 320-x may be associated with link 15-x of FIG. 1 (e.g., via PHY layer 300-x), LMAC layer 320-y may be associated with link 15-y (e.g., via PHY layer 300-y), and LMAC layer 320-z may be associated with link 15-z (e.g., via PHY layer 300-z). That is, each link 15x/y/z may have an associated LMAC layer 300-x/y/z that performs link-specific features, such as channel access.

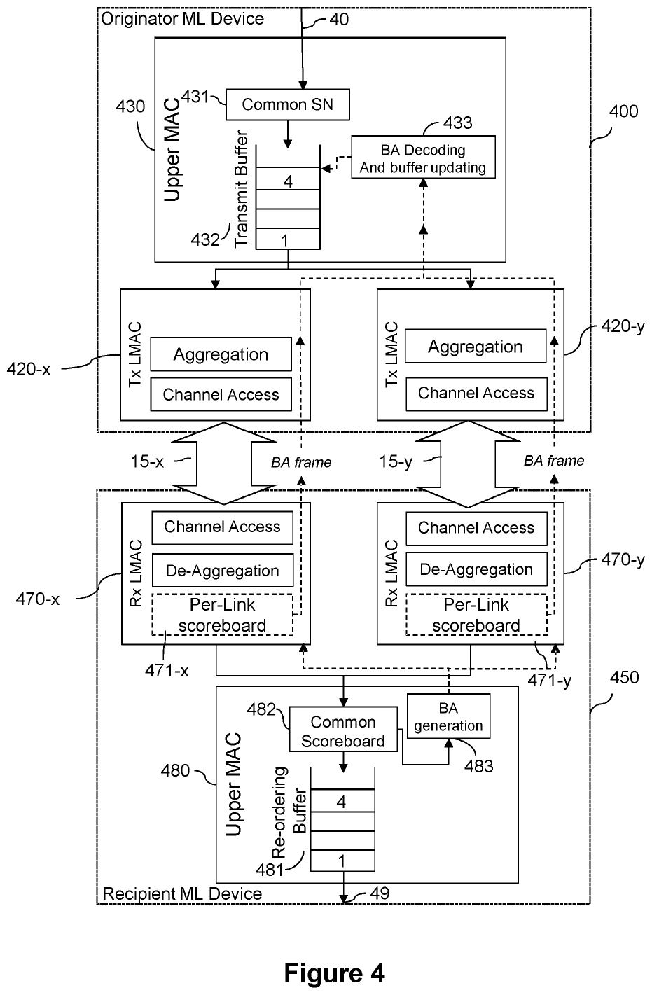

Operations for ML data transmission are now illustrated with reference to FIG. 4. This Figure shows an originator ML device 400 and a recipient ML device 450 (the PHY layers are not shown for simplification). The originator and recipient ML devices may be both ML non-AP devices 11 or one may be a ML AP device 10. Any ML device may include the blocks shown at the originator ML device 400 for transmission operations and those at the recipient ML device 450 for reception operations. However, in the example shown, the ML devices share only two links 15-x, 15-y.

ML non-AP devices always establishes a multi-link association with a ML AP device in a multilink set (set of ML devices). The association framework allows a ML non-AP device to have frame exchanges with any ML AP device for the purpose of association. In practice, one of the link (i.e. one of the affiliated stations) may be used by the ML non-AP device to associate with the ML AP device (through the corresponding affiliated AP station) and discovery procedures may be implemented to discover the other links that can be established between the same ML non-AP device and ML AP device. This link may be considered as a “primary link” or “anchor link”.

Exchanged information may include BSS configuration, AP information on each link, non-AP STA information on each link, capability of each link, Tx/Rx constraints of the multiple links.

Each time a ML device needs to exchange data, it establishes a multilink communication session.

During a setup phase, it may exchange information and negotiate policies for the multiple links of the ML communication session. Also one or more links can be established at a specific time, where the term “established” of a link means that each ML device has all the information to enable data operation with the other ML device in that link. Note that other terms may be used for the concept for both sides to have all the necessary information of a link.

Negotiated policies may include an acknowledgment (ack) scheme, in particular an agreement regarding the terms and capabilities for the BA session (e.g., using an add BA (ADDBA) request and response procedure). The negotiating ML devices may exchange capability information such as BA size (size of scoreboard bitmaps), buffer size, window size (e.g., a sliding window), the sequence number space to be used, and/or policy, and then agree on the common parameters to use. The BA agreement may be later torn down (e.g., using a delete BA (DELBA) request).

A single block ack agreement is negotiated between the two ML devices for a given traffic (i.e. TID) that may be transmitted over one or more links, meaning that it is negotiated at UMAC level regardless of the links to be used. For each block ack agreement (i.e. in case several TIDs are transmitted), there exists one receive reordering buffer based on MPDUs in the recipient ML device.

Thanks to the multilink scheme, the data units belonging to the same TID can be simultaneously transmitted over multiple links.

UMAC 430 of the originator receives application data 40 as an input (e.g., in the form of MAC service data units, MSDUs). The received MSDUs may form MPDUs alone or according to an A-MSDU aggregation. UMAC 430 attaches a common sequence number (SN) to the MPDUs at block 431 and allocates these MPDUs to a common transmit queue or buffer 432. Alternatively, the transmit queue 432 may store MSDUs (and not MPDUs) in which case the sequence numbering ensures determining the MSDU frame(s) corresponding to a given MPDU encapsulation. More generally, data units are stored in the transmit queue 432, sequence numbers being associated with them to keep information on their order.

A single transmit queue 432 may be used for the four EDCA ACs. Alternatively, multiple transmit queues may be used, each of which being associated with a respective AC.

The stored data units may then be routed from the transmit queue 432 to one of Tx LMAC 420-x or Tx LMAC 420-y (i.e. to one of its affiliated stations), usually depending on which link 15-x or 15-y offers communication resources for the originator ML device 400. UMAC 430 thus performs the allocation of the data units (MPDUs) to the multiple links 15-x, 15-y. Note that the same sequence number space is used across all links since the sequence numbering is performed at UMAC level.

The data units are then transmitted over the multiple links, for instance using MPDU aggregation and channel access.

The transmitted data units are received by the recipient ML device 450 through its multiple affiliated stations, i.e. through its multiple Rx LMAC 470-x, 470-y. This depends on which link 15-x, 15-y, the originator has transmitted the data units.

A block acknowledgment (BA) is independently performed per link where a scoreboard is built (blocks 471-x and 471-y) and sent to the originator as a BA frame, upon request (BA Request) or upon receiving a number of data units, over the corresponding link. As example, at the end of a TXOP used by a link 15, a BA frame may have to be sent in order to close the communication. This is because the BA frame should be received in the current TXOP session (“Immediate Block Ack” policy).

The per-link scoreboard is a BA bitmap comprising bits associated with respective sequence number (from an agreed starting sequence number, SSN), a bit taking the 0-value if the data unit with the corresponding sequence number has not been correctly received over the associated link at the time of building the bitmap or the 1-value if the data unit has been correctly received. Per-link scoreboards may be implemented as partial-state of reception.

The BA mechanism improves channel efficiency by aggregating several acknowledgments into one frame. The BA bitmap is generated for a particular TID.

The received and decoded data units are forwarded by each Rx LMAC 470 to UMAC 480 for storage in a common re-ordering buffer 481 (i.e. a common receive queue). In that way, UMAC may consolidate the data units arriving over the multiple links, perform block ack scoreboarding, MPDUs reordering, etc. Again, a shared common re-ordering buffer 481 may be used for the four EDCA ACs, or multiple re-ordering buffers may be used.

The recipient ML device 450 may also maintain a common scoreboard 482 to keep a longer term record of the received data units for a multilink TID (not limited by TXOPs). The common scoreboard may be implemented as full-state. The common scoreboard is updated regularly with the content of the per-link scoreboards, e.g. every time a per-link scoreboard is updated, or at a very minimum at the end of each link's TXOP. The common scoreboard has thus a bigger size than the per-link scoreboards. However, it is still generated for a particular TID.

The common scoreboard 482 is used by block 482 to generate a BA frame.

The BA frame is transmitted to the originator ML device 400 using one or more of the multiple links 15-x, 15-y. A single BA may be sent back for the multiple links 15, preferably upon receiving a BAR request frame from the originator ML device 400. Typically, the recipient ML device 450 would need to transmit the bitmap of the different BA sessions. This implementation allows “Delayed Block Ack”, but also supports an “Immediate Block Ack” policy if the ML device is responsive enough.

The received BA frame and/or the per-link scoreboard (also BA frames) are used by the originator ML device to manage transmit buffer 432, in particular to remove acknowledged data units (MPDUs and so the corresponding encapsulated MSDUS) therefrom based on their acknowledgment by the recipient. In the multilink context with at least two links active, only the 1-value of the bits in the bitmaps/scoreboards is significant: it indicates the corresponding data unit has been correctly received. The 0-value is no longer significant as it only indicates the data unit has not yet been received, however without specifying whether it was lost or not yet arrived (because transmitted over another link). This sharply contrasts with the legacy behavior (of oldest IEEE 802.11 versions), wherein each successive bit value in the BA bitmap defines the acknowledgment status of each successive data unit starting from the SSN (Starting Sequence Number—identified in BA frame).

Based on the received BA bitmaps/scoreboards, buffer updating module 433 removes the data units correctly received by the recipient (i.e. those whose bit in the BA bitmap has a 1-value). This operation frees space in the transmit buffer 432 to allow new data 40 to populate the buffer in order to be transmitted.

On the contrary, those data units for which the corresponding bit in the BA bitmaps has a 0-value are either lost or not yet received. Due to this uncertainty, retransmissions may take a while depending on which delay the originator ML device will take into account to consider a data unit is lost compared to a simple late delivery on one of the multiple links.

For instance, the originator ML device may consider that each BA frame generated at UMAC level (i.e. by block 483, as a BA frame of a delayed-BA policy) corresponds to a transmission result, because it may be considered that the sent data units have sufficient time to reach the recipient before the generation of a delayed-BA frame. Alternatively, the originator ML device may use a predefined timer for each transmitted data unit and consider the next BA frame after timer expiry as providing the real reception state of the data unit.

Any failed data unit (i.e. with the 0-value for the corresponding bit in the relevant BA frame) is retransmitted by the originator ML device, possibly using a different link 15 from the one on which it was originally transmitted and lost, or alternatively using the same link 15.

At the recipient side, the received data units are reordered upon arrival in the UMAC 480 and then stored in the re-ordering buffer 481 in the original order. The receive reordering buffer operation is based on the Sequence Number space that is shared between the two ML devices.

Next, they are successively provided 49 to the upper layers 360 (FIG. 3) following the original order, meaning that preceding data units (according to the sequence numbering) have to be yet delivered before the next correctly received data unit is delivered to the upper layers.

As the MLO feature increases the peak/average throughput of the ML devices, it is adapted to bandwidth-demanding and low-latency traffics, e.g. video-based services such as gaming, virtual or augmented reality, streaming applications, emergency services, etc.

As mentioned above, IEEE 802.11 specification addresses traffics using traffic identifiers TID which are stored in access categories AC. Through multi-link aggregation, MPDUs that belong to the same TID can be transmitted on multiple links. BA agreement is established per TID, meaning that all links for a given TID have the same ACK policy. BA agreement is needed because the low latency traffic data in fact also includes some data (such as control data) that require reliability.

In fact, it is often that traffic streams combine low-latency data and data requiring a high level of reliability.

For instance, a video traffic usually includes a video stream that does not need a high level of reliability (because losing some data does not substantially impact the video rendering), and includes an associated control data stream that requires a high level of reliability.

In another example based on TID duplication, a data traffic may be duplicated and conveyed over several links wherein the level of reliability could be decreased for the transmission over some links.

However, it is commonly accepted that acknowledgment policy refrains low latency delivery. In particular, retransmission of low latency frames may appear useless and may thus reduce the efficiency of MAC protocol in term of bandwidth usage and latency delivery.

For instance, still with reference to FIG. 4, the originator ML device has to wait the acknowledgment by the recipient of low-latency data units before removing them from the transmit buffer 432 and thus freeing space to transmit new data units. It turns that transmission speed is not optimized.

Similarly, in the re-ordering buffer 481, the low-latency data units cannot be delivered to the upper layers as long as all the preceding data units (regardless of whether they are low-latency data units and/or data units with a high level of reliability) have been correctly received and delivered. This phenomenon is called Head-of-Line Blocking problem in FIFO queues. Head of Line blocking is known to reduce the efficiency of MAC protocol in term of latency delivery.

In this context, there is a need to facilitate the transmission of low-latency data units of a TID when a multilink operation (such as in 802.11 be) is implemented with an acknowledgment policy.

It is proposed to dedicate one (or more) specific link from amongst the multiple links 15 to convey data units for which the buffer management rules (data unit removal from buffer 432 and data unit delivery/removal from buffer 481) are not applied (or are inhibited) by originator and recipient ML devices. In other words, the data units stored in the communication buffer (buffer 432 or 481) that are exchanged over the specific link are managed in the communication buffer regardless of the management rule. Traffic discrimination may thus be based on a sub-TID granularity, whereas the TID remains controlled under a common acknowledgment policy (with ack enable).

This specific link may thus be used to convey the low-latency data units: the data units exchanged over the specific link are low-latency data compared to the data units exchanged over a separate link.

As the management rule does no longer apply for these (low-latency) data units, they can be removed from transmit buffer 432 without waiting for an associated acknowledgment and thus they speed up the transmission throughput; and they can be delivered from re-ordering buffer 481 to the upper layers without waiting that all the preceding data units have been correctly received, and thus they improve low-latency quality for the high level applications.

The specific link according to the invention may be seen as a “no-ack link” in the meaning that the buffer management is operated for the corresponding data units without taking into account the acknowledgments made by the recipient ML device. As described below, acknowledgments by the recipient ML device may still survive, even for the data units conveyed over the no-ack link. This is to keep the conventional BA mechanisms.

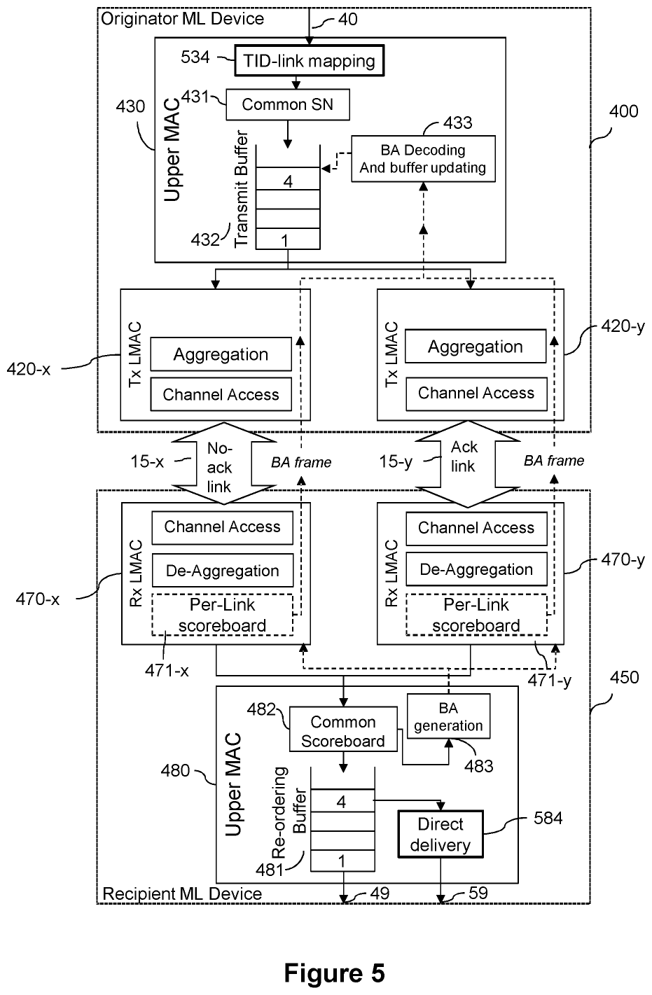

FIGS. 5, 6 and 8 illustrate various exemplary embodiments according to the teachings of the invention, using the same blocks as FIG. 4. In these exemplary embodiments, a ML device implements at least two links (two links are shown, however another number of links may be envisioned), one of which being the specific no-ack link for low-latency data units. The negotiation on which link is a no-ack link may be made during the setup phase between the originator and recipient ML devices. In a variant, the no-ack link may be predefined (e.g. the links established on the x GHz band are no-ack links). Note that the no-ack link for the transmission of a data traffic (TID) may be different from the no-ack link for another data traffic or be the same.

The global Ack policy of the ML device still remains an acknowledgment policy, meaning that a separate link is kept for which the data units still follow the conventional buffer management rules: a stored data unit that is exchanged over the separate link is removed from transmit buffer 432 upon receiving a respective data unit acknowledgment from the recipient ML device and the same data unit stored in the re-ordering buffer 481 is delivered to the upper layer depending on a sequence ordering of correctly received data units.

Note that in case power saving mode is applied for the ML device (links are shutdown if not used), there always remains a separate link with acknowledgment (for instance an anchor link that can never be deactivated during the ML communication session), meaning that the no-ack link may be deactivated.

With reference to FIG. 5, UMAC 430 of the originator still receives application data as an input (e.g., in the form of MAC service data units, MSDUs).

According to the invention, the UMAC 430 needs to correctly direct or route the data units to the no-ack link (e.g. 15-x) or to the ack link (e.g. 15-y) depending on the data units. The TID-to-link mapping module 534 performs such switching.

The originator ML device 400 may comprise one or more common transmit queues 432, each of which is associated with a given Traffic Identifier (TID).

All the data traffic coming from the upper layers may be subject to TID-to-link mapping. In a variant, only some of them may be subject to the mapping.

For instance, upper layers 360 may provide data frame, MSDU, with 802.1D User Priority (UP) values taken in the reserved 8-15 values (known as TSID) for low latency delivery services. Using TSID is an easy indication means for selecting the appropriate transmission mode. In that case, TID-to-link mapping module 534 may perform the routing according to embodiments of the invention for the data traffic with TSID=8 to 15 and may act in a conventional manner for the data traffic with conventional TID=0 to 7. Therefore, only the transmit queue associated with a Traffic Identifier value (TID) greater than 7 will see part of its stored data units sent over the no-ack link 15-x.

In a variant, the data frames, MSDUs, received from the upper layers have always a conventional UP/TID value between 0 and 7 and the TID-to-link mapping module 534 can feed a transmit queue 432 associated with a TSID=8 to 15 with selected MSDUs in order to apply the routing according to the invention only for those queues with TSID=8 to 15. The selection may for instance be based on upper layer information, such as the application emitting the MSDUs, an application port, etc.

Of course, other criteria may be used by the TID-to-link mapping module 534 to identify whether a data traffic (TID) should be subject to the routing according to the invention.

Routing rules are next applied to the concerned data units stored in the transmit buffer 432 to direct them either to Tx LMAC 420-x (for no-ack link 15-x) or to Tx LMAC 420-y (for ack link 15-y).

Routing criteria may be based on upper layer information.

For example, an used upper-layer protocol (e.g. TCP vs. UDP) can be used to discriminate between MSDUs of the same UP/TID: for instance, those data units implementing TCP favor data quality over speed and thus can be routed to Tx LMAC 420-y, while those data units implementing UDP favor speed over data quality and thus can be routed to Tx LMAC 420-x for transmission over the no-ack link 15-x.

Another example of routing criterion may include the use of the “type of service” (TOS) field in the IP header of the data units. This field may indicate the level of reliability required, and therefore whether acknowledgment and retransmission are required (if needed). Thus, anyway the TID is, (at least) one bit in the TOS field of each MSDU of a given TID may be selected to discriminate part of the traffic to be delivered on specific links. As example, the 4th bit of TOS field (called Delay flag) indicates whether or not low delay is preferred (therefore the tagged MSDUs may be routed to the no-ack link); the 5th bit (called Throughput flag) indicates whether or not high throughput is preferred (so link aggregation is performed on at least 2 links with one link acting as a no-ack link); the 6th bit (called Reliability flag) indicates whether or not high reliability is preferred (therefore those MSDUs with high reliability should not be expedited on the no-ack link).

Once the data units stored in transmit buffer 432 are routed to the appropriate Tx LMAC, the stored data units that are exchanged over the specific no-ack link 15-x are removed from the buffer upon routing to Tx LMAC 420-x, i.e. upon transmission over the specific link. No acknowledgment is waited for, ensuring the removal is regardless of any respective data unit acknowledgment from the recipient ML device. UMAC 430 may perform such removing operation based on the TID-to-link mapping done.

On the contrary, the stored data units that are exchanged over the other link (ack link 15-y) can remain in transmit buffer 432 as long as their acknowledgment is not received from the recipient ML device.

At the recipient side, the no-ack link 15-x is known because it has been negotiated, for instance during the setup phase. Consequently, the recipient ML device is fully able to discriminate the link origin of any received data unit. This task is performed by the direct delivery module 584 in order to accordingly manage the data units stored in the re-ordering buffer 481.

The stored data units that are exchanged over the specific no-ack link 15-x are delivered (reference 59) to the upper layer regardless of a sequence ordering of correctly received data units, i.e. regardless of the acknowledgment of preceding data units. Those data units (of the no-ack link) may thus be immediately delivered (i.e. upon reception thereof) to the upper layers. Furthermore, the stored data units are removed from the buffer upon being delivered to the upper layer. This behaviour shows that the proposed traffic discrimination based on sub-TID granularity reduces the head-of-line blocking effect.

On the contrary, the stored data units that are received over the separate ack link 15-y are not delivered to the upper layer and remain in the re-ordering buffer 481 as long as the preceding data units are not correctly received and delivered to the upper layer (this is the conventional behaviour). As preceding data units that are missing may be lost on the no-ack link, they will never be retransmitted and would not liberate the stored data units: the stored data units may be delivered later on upon the reception of a Block-Ack-request frame with a starting sequence number block greater than the sequence number of missing data units. Optionally, the receiver seeing no further retransmission for the missing data units in following data unit transmissions on the ack-link may interpret those missing preceding data units as unreliable (alternatively, when retransmissions occur, still missing data units preceding any retransmitted data units can also be ignored).

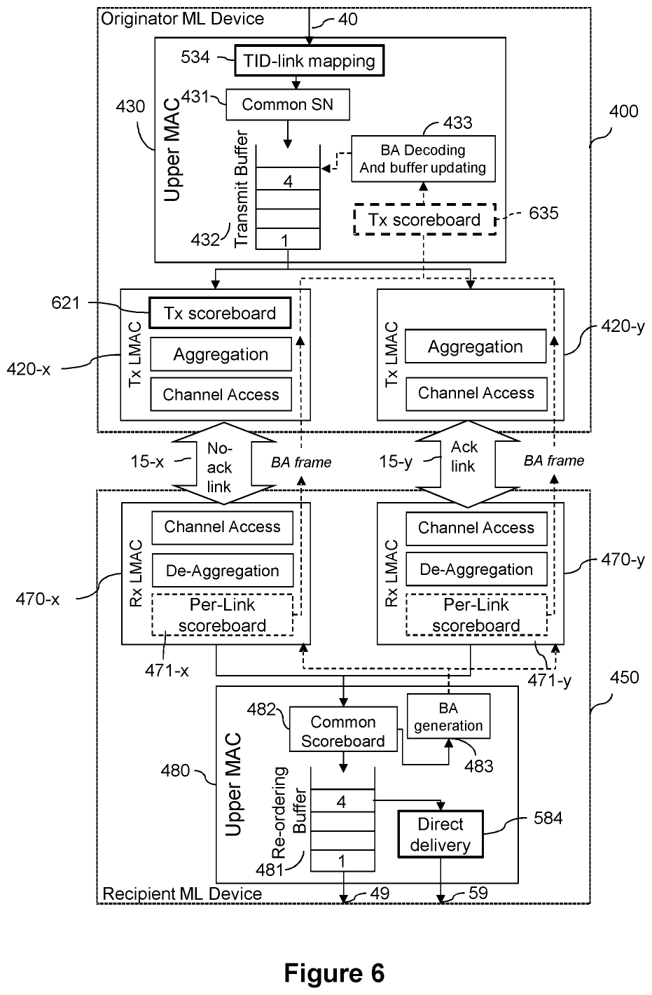

FIG. 6 shows a variant where the MAC layer 320 locally builds an acknowledgment scoreboard upon transmitting stored data units over the specific no-ack link, wherein the acknowledgment scoreboard acknowledges the transmitted data units. This acknowledgment scoreboard is then used to update the transmit buffer 432, in particular to remove these data units from the buffer. This behaviour is contrary to prior art where only recipients maintain a scoreboard.

The advantage of this variant is to keep a conventional buffer management based on a BA bitmap. This is because the built acknowledgement scoreboard may be locally transmitted to the buffer updating module 433 in a block acknowledgment frame format. The locally-built BA bitmap (scoreboard) is used to mislead the buffer updating module 433: the latter believes that the data units have been actually received by the recipient ML device. The misleading ensures no retransmission of the data units (transmitted over the no-ack link 15-x) will take place.

As shown in the Figures, this variant adds block 621 corresponding to the local Tx scoreboard 621.

The scoreboard is built by the Tx LMAC 420-x associated with the no-ack link 15-x. If two or more links are no-ack links, a local Tx scoreboard may be built by each corresponding Tx LMAC (for the same TID).

In a variant, the local Tx scoreboard 635 may be built by UMAC 430 for all the no-ack links (for the same TID).

The originator ML device maintains Tx scoreboard 621 (or 635) with a starting sequence number (SSN) and a bit for each data unit dedicated to the no-ack link 15-x, per each of established MLD's BA agreements. For Tx scoreboard 621 at Tx LMAC level, the bit may be marked (value 1) for each data unit locally received from UMAC 430 (this is because all these data units are to be transmitted over the no-ack link 15-x). For Tx scoreboard 635 at UMAC level, the bit may be marked (value 1) for each data unit locally routed to Tx LMAC 420-x implementing the no-ack link.

The Tx scoreboard may be transmitted as an acknowledgment frame (with a BA bitmap) to the buffer updating module 433 periodically, upon request or according to any other criterion. As all the data units transmitted over the no-ack link 15-x are marked as “acknowledged” in the Tx scoreboard, the module 433 retrieves the corresponding sequence numbers and clears the data units from the transmit buffer 432, regardless of their actual reception by the recipient ML device (and thus regardless of any acknowledgment by the recipient).

It is to be noted that the data units not acknowledged in the Tx scoreboard, i.e. those sent over ack links 15-y (marked with the value 0 in the bitmap), have to be ignored by the buffer updating module 433. This is because, as explained above, with the MLO feature, the 0-value in the BA bitmap no longer means only the data unit is lost. The 0-value now indicates the data unit has not yet been received. The 0-value ignoring by the buffer updating module 433 ensures the Tx scoreboard-based approach of the invention efficiently works without provoking unnecessary retransmissions.

This approach thus discloses a method of managing an immediate block acknowledgement scoreboard by an originating station (Tx LMAC 420-x) of an originator ML device, the method comprising emitting towards a UMAC entity of the originator ML device a (virtual) bitmap marking the bits corresponding to all MPDUs transmitted through this originating station with the value 1 (i.e. as acknowledged).

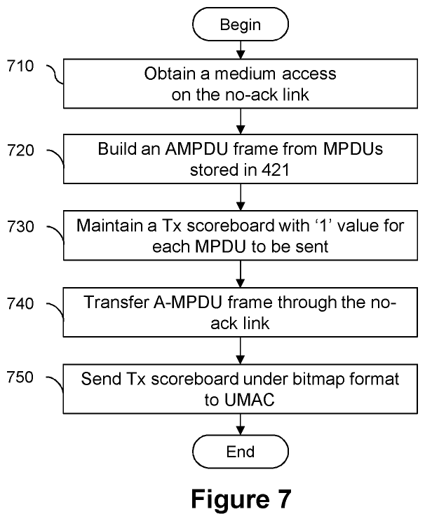

FIG. 7 illustrates, using a flowchart, exemplary steps to manage the Tx scoreboard. These operations are preferably performed at LMAC level (in each Tx LMAC 420-x corresponding to a no-ack link 15-x). However, they may be implemented at UMAC level when UMAC 430 manages one or more Tx LMAC corresponding to no-ack links.

At step 710, the Tx LMAC 420-x (more generally the Tx LMAC corresponding to no-ack links) obtains a timeslot for communication over the no-ack link 15-x. The timeslot may be obtained by the LMAC itself or be granted from another station (e.g. AP operating on the no-ack link, or a station of the recipient ML device 450). The communication may follow any of single-user or multi-user schemes.

The Tx LMAC performs conventional operations to prepare its communication over the no-ack link, notably by preparing an A-MPDU frame, comprising a series of MPDUs pending in the transmit buffer 432 (for the TID considered) dedicated for the no-ack link (low-latency data units) and that fit into the obtained timeslot. This is step 720.

At step 730, all sequence numbers for MPDUs that form the A-MPDU are stored in the local Tx scoreboard 621. The Tx LMAC 420-x maintains this information in a scoreboard with a starting sequence number (SSN) and a bit marking each of these MPDUs as acknowledged (i.e. bit with value 1).

As an example, the SSN number is the sequence number of the first MPDU for which no acknowledgment is yet locally performed.

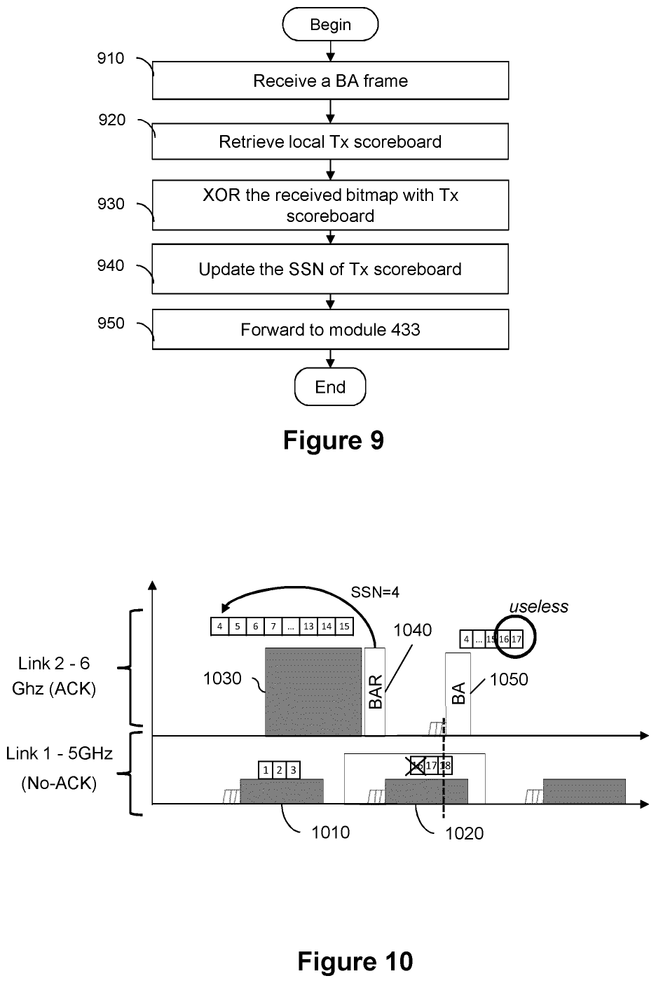

Optionally, the SSN number remains the same until the Tx LMAC receives a BA frame bypassing this sequence number from the recipient ML device (step 940 of FIG. 9 below).

Next, the Tx LMAC 420-x sends the A-MPDU at step 740 over the no-ack link 15-x.

Once the transmission is done (anyway the success or failure), the Tx scoreboard information is pushed to UMAC 430, preferably using the format of a BA frame, thereby pushing misleading information that all transmitted MPDUs were successfully transmitted. This is step 750.

Step 750 may be performed simultaneously to step 740.

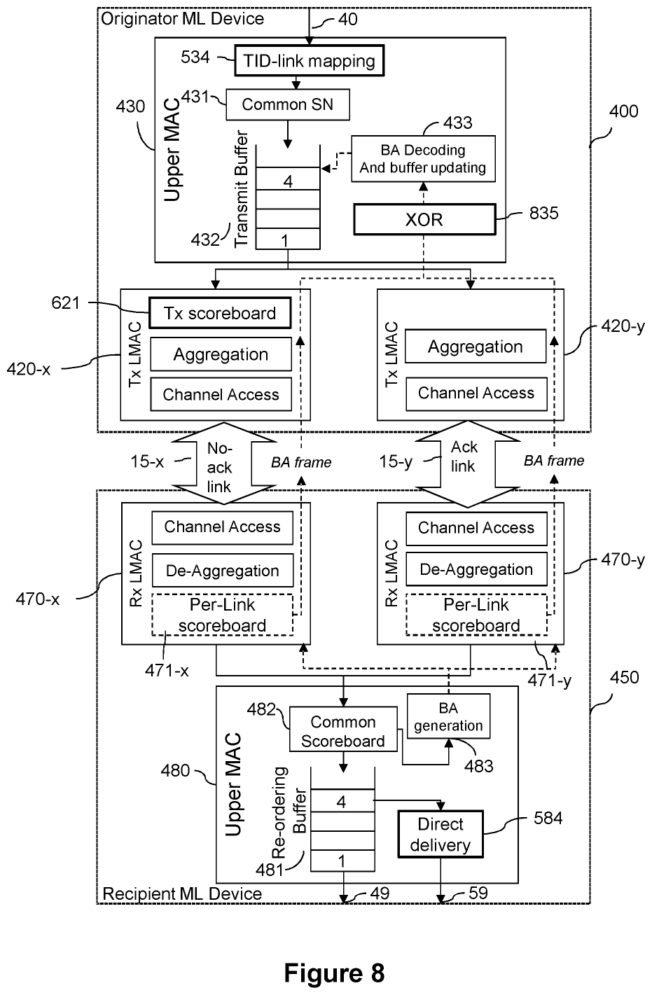

FIG. 8 shows another variant to FIGS. 5 and 6 where an acknowledgment record (BA frame) received from the recipient ML device is modified based on the acknowledgment Tx scoreboard 621. This allows the received BA frame to be supplemented with (virtual) acknowledgment of the data units transmitted over the no-ack link or links 15-x, thereby still misleading the buffer updating module 433 (on whether these data units have indeed been correctly received or not by the recipient). This approach also allows discrepancies between the Tx scoreboard 621 and the BA frame received from the recipient (e.g. Tx scoreboard indicates ‘1’ for a data unit transmitted over the no-ack link while the BA frame indicated ‘0’ for the same data unit) to be suppressed, avoiding uncertainty when updating the transmit buffer 432.

This variant adds block 835 performing the modification of the received BA frame. Block 835 receives the local Tx scoreboard 621 and the BA frame from the recipient 450. If several local Tx scoreboard are generated for several no-ack links (for the same TID), they can be merged into a single common Tx scoreboard before being processed by block 835. The merger simply aligns the local Tx scoreboard according to the sequence numbering and performs an XOR operation.

Block 835 then performs a XOR between the local (or common) Tx scoreboard and the BA bitmap of the received BA frame. This ensures all the data units transmitted over the no-ack links to be acknowledged in the BA bitmap ultimately used to update the transmit buffer 432.

This approach thus discloses a method of locally modifying the bits of a BA record received from a recipient ML device depending on which link the data units corresponding to the bits have been transmitted. A modification is made in case of a no-ack link to set the data units as acknowledged, while no modification is made in case of an ack link.

FIG. 9 illustrates, using a flowchart, exemplary steps to perform the modification of a BA frame upon reception thereof from the recipient ML device 450.

These operations are preferably performed at UMAC level by block 835. However, it may be partly or fully implemented at Tx LMAC level, for instance in block 621.

The algorithm starts at step 910 when a BA frame is received from the recipient ML device 450. The BA frame may be received on any link from amongst the multiple links of the session, no-ack links or ack links.

Preferably, the BA frame reports acknowledgment of the data units (of a given TID) exchanged over any of the active links (no-ack link 15-x and ack link 15-y, and any other active link of the session).

At step 920, the local or common Tx scoreboard 621 is retrieved and is aligned to the received BA frame (according to the sequence numbering). For instance, at least a part of the BA bitmap of the received BA frame may correspond to the data units following the SSN maintained in the Tx scoreboard.

At step 930, the BA bitmap of the received BA frame is modified based on the retrieved Tx scoreboard to set all the data units transmitted over a no-ack link 15-x as acknowledged. The aligned received BA bitmap may be XORed with the Tx scoreboard, meaning that a XOR is performed only between the bits (of the bitmap and the scoreboard) corresponding to the same sequence number. This leads to have each bit at ‘1’ in the scoreboard be set at ‘1’ in the BA bitmap.

At optional step 940, the SSN of the Tx scoreboard is updated to clear history. The new SSN may be set to the number following the last XORed number of the received BA bitmap.

Next step (step 950) consists in pushing the modified BA bitmap to buffer updating module 433 in order to manage (update) the transmit buffer 432 in a conventional manner.

Note that although the XOR block 835 is shown at UMAC layer in FIG. 8, similar XOR blocks may be provided at Tx LMAC level 420-x in order to modify the per-link scoreboard received from block 471-x.

FIG. 10 illustrates an exemplary timeline of a communication exchange according to embodiments of present invention.

A given traffic flow (one TID) with data units numbered from 1 to 18 is split onto two links using any mechanism described above, wherein link 1 is a no-ack link offering low-latency delivery and link 2 is a conventional ack link. In the example shown, the two links occupy 5 Ghz and 6 Ghz frequency bands. The number of links may be different from two and other frequency bands may be used. For instance, the links may be on the same frequency band of operation, as long as they do not encompass same frequencies (they shall not have the same primary channel). Generally, links of the same ML device do not occupy contiguous channels.

In the example, data units with sequence numbers 1-3 and 16-18 are identified as required low-latency delivery for the embedded MSDUs. Consequently, they have to be conveyed over no-ack link 1, for instance in a first PPDU 1010 (for SN=1-3) and a second PPDU 1020 (for SN=16-18). Data units with other sequence numbers (4-15) are allocated to not-time-sensitive data flow, and thus can be transmitted over ack link 2. These data units are for instance aggregated into a single PPDU 1030).

No BA frame is conveyed over link 1 as no BAR frame is sent by the originator ML device over this link. Such BA request 1040 is made on link 2 after PPDU 1030. Possibly, the SSN in the BAR frame is set to the first transmitted sequence number on that link (or at least the last acknowledged sequence number), which is the number 4 in the example. We may suppose that it is SN=4 because the BAR is issued by Tx LMAC 420-y for instance.

According to implementations, the BAR may be generated by transmit buffer 432 in order to request buffer flushing. Therefore, the SSN of BAR may still be the number 4, as a local bitmap was already generated by ‘TX Scoreboard’ module 621 and handled by module 433 according to embodiments of the invention.

Alternatively, the local bitmap may not yet be constructed so the lower SSN value could be requested in the BAR frame (e.g. value 1): this case is handled in the same manner as for sequence numbers 16 and 17 discussed below.

In the sequence of FIG. 10, BA frame 1050 is sent by the recipient ML device responsive to the BAR 1040 (e.g. Delayed-BA policy). Immediate BA policy is also compatible, without BAR.

BA frame 1050 is emitted over link 2, approximately at the same timing as other transmissions on no-ack link 1. This clearly shows that the proposed scheme supports asynchronous operations between the links, and thus part of PPDU 1020 (with SN=16-18) could not have been received by UMAC of the recipient when BA frame 1050 is generated by recipient ML device (as example, data unit with SN=18 is not completely received and is not yet stored in the re-ordering buffer 481).

As a result, the sequence numbers 16 and 17 may have been entered in the Common Scoreboard 482 at the recipient ML device.

In the proposed scenario, MPDU with SN=16 has been corrupted during the transmission, whereas MPDU with SN=17 is correctly received.

The ‘BA Generation’ module 483 then constructs a BA bitmap with a 0-value in the bit corresponding to SN=16 and a 1-value for SN=17. The bit for SN=4 to 15 are not illustrated (but depends on how the corresponding MPDUs are received), as the description focuses on the data units transmitted over the no-ack link 1. In the prior art, such BA bitmap would request the retransmission of MPDU with SN=16.

According to the invention, once the BA frame 1050 is received by the originator ML device, it is XORed with local Tx scoreboard 621, by module 835. As the local Tx scoreboard has a bit for SN=16 set to 1 (because sent over no-ack link 1), the XOR operation tends to modify the BA frame 1050 so that the bit for SN=16 becomes 1.

In other words, any MPDU conveyed on no-ack link 1 and having a bit indicated as lost or corrupted in the BA frame 1050 becomes acknowledged after the modification (i.e. its corresponding bit is updated to value 1). As this MPDU is now considered as correct in the BA report, there is no need for the originator ML device to retransmit it.

In the example, bit for SN=16 of the received BA bitmap 1050 is XORed with a ‘1-value’ bit of the local Tx scoreboard 621, so is updated to 1; bit for SN=17 of the received BA bitmap 1050 is XORed with a ‘1-value’ bit of the local Tx scoreboard 621, so remains to 1. MPDU sequences 1,2,3 would never be requested as the SSN (in the BAR) is 4.

As a result of the proposed schemes, an intra-TID selection is performed onto a traffic flow (of a given TID), wherein part of the frames is conveyed over a no-ack link (to avoid retransmission of those low-latency frames) and remaining part of the frames can be transmitted over a distinct link offering a conventional acknowledgment service.

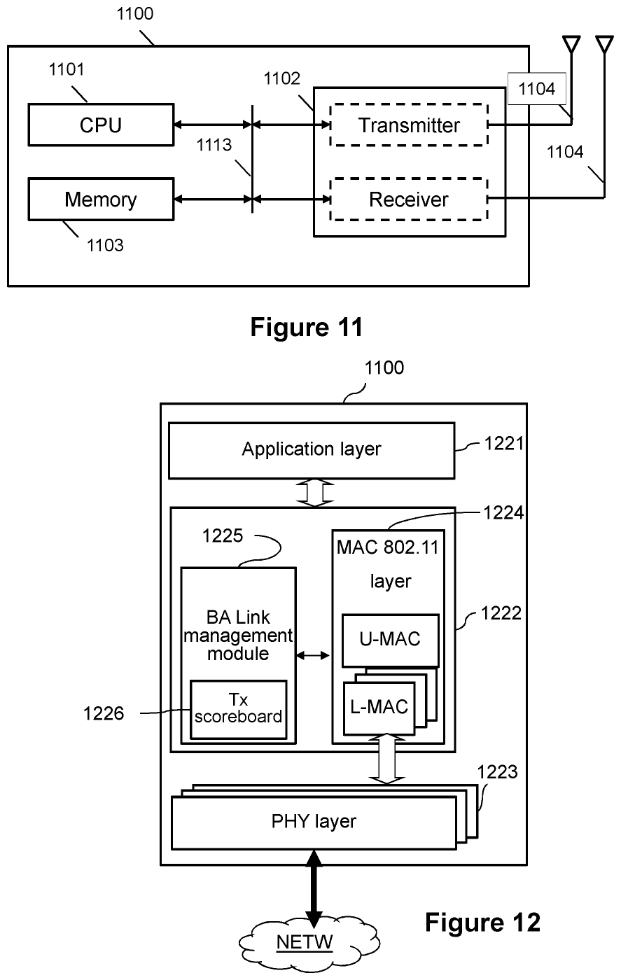

FIG. 11 schematically illustrates a communication device 1100, either a ML non-AP device (embedding a plurality of non-AP stations 110-170) or a ML AP device (embedding a plurality of APs 100), of a radio network NETW, configured to implement at least one embodiment of the present invention. The communication device 1100 may preferably be a device such as a micro-computer, a workstation or a light portable device. The communication device 1100 comprises a communication bus 1113 to which there are preferably connected:

a central processing unit 1101, such as a processor, denoted CPU;

a memory 1103 for storing an executable code of methods or steps of the methods according to embodiments of the invention as well as the registers adapted to record variables and parameters necessary for implementing the methods; and

at least one communication interface 1102 connected to a wireless communication network, for example a communication network according to one of the IEEE 802.11 family of standards, via transmitting and receiving antennas 1104.

Preferably the communication bus provides communication and interoperability between the various elements included in the communication device 1100 or connected to it. The representation of the bus is not limiting and in particular the central processing unit is operable to communicate instructions to any element of the communication device 1100 directly or by means of another element of the communication device 1100.

The executable code may be stored in a memory that may either be read only, a hard disk or on a removable digital medium such as for example a disk. According to an optional variant, the executable code of the programs can be received by means of the communication network, via the interface 1102, in order to be stored in the memory of the communication device 1100 before being executed.

In an embodiment, the device is a programmable apparatus which uses software to implement embodiments of the invention. However, alternatively, embodiments of the present invention may be implemented, totally or in partially, in hardware (for example, in the form of an Application Specific Integrated Circuit or ASIC).

FIG. 12 is a block diagram schematically illustrating the architecture of the communication device 1100, adapted to carry out, at least partially, the invention. As illustrated, device 1100 comprises a physical (PHY) layer block 1223, a MAC layer block 1222, and an application layer block 1221.

The PHY layer block 1223 (here a multiple of 802.11 standardized PHY layer modules) has the task of formatting, modulating on or demodulating from any 20 MHz channel or the composite channel, and thus sending or receiving frames over the radio medium NETW, such as 802.11 frames, for instance medium access trigger frames to reserve a transmission slot, MAC data and management frames based on a 20 MHz width to interact with legacy 802.11 stations, as well as of MAC data frames of OFDMA type having smaller width than 20 MHz legacy (typically 2 or 5 MHz) to/from that radio medium.

The MAC layer block or controller 1222 preferably comprises a MLE MAC 802.11 layer 1224 implementing conventional 802.11 MAC operations, and additional block 1225 for carrying out, at least partially, embodiments of the invention. The MAC layer block 1222 may optionally be implemented in software, which software is loaded into RAM 1103 and executed by CPU 1101. The MLE MAC 802.11 layer 1224 may implement an Upper-MAC stack 330 along with a series of Lower-MAC modules 320-x/z.

Preferably, the additional block 1225, referred to as BA Link management module for performing low-latency service over multi-link communications, implements part of embodiments of the invention (either from station perspective or from AP perspective).

For instance, and not exhaustively, the operations for the station (AP or non-AP) may include: discriminating passenger traffic by intra-TID classification (to discriminate between low-latency data units and data units requiring reliability); generating and sending a multi-link request/response frame establishing a no-ack link for a ML device involving an acknowledgment policy; generating a local Tx scoreboard 621 by the originating station 110-170; and modifying any received BA record 1050 based on the generated Tx scoreboard 621.

MAC 802.11 layer 1224 and BA Link management module 1225 interact one with the other in order to establish and process accurately communications over the no-ack and ack links in between multiple ML non-AP stations according to embodiments of the invention.

On top of the FIG. 12, application layer block 1221 runs an application that generates and receives data packets, for example data packets such as a video stream. Application layer block 1221 represents all the stack layers above MAC layer according to ISO standardization.

Although the present invention has been described hereinabove with reference to specific embodiments, the present invention is not limited to the specific embodiments, and modifications will be apparent to a skilled person in the art which lie within the scope of the present invention.

Many further modifications and variations will suggest themselves to those versed in the art upon referring to the foregoing illustrative embodiments, which are given by way of example only and which are not intended to limit the scope of the invention, that being determined solely by the appended claims. In particular, the different features from different embodiments may be interchanged, where appropriate.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

1. A communication method, at an originator multilink, ML, device storing data units in a transmit buffer, comprising:
establishing a multilink communication session with a recipient ML device to transmit the stored data units over multiple links based on an acknowledgment scheme acknowledging correct reception of the data units,
transmitting the data units over the multiple links, and
removing stored data units from the transmit buffer based on corresponding data unit acknowledgments received from the recipient ML device,
wherein the stored data units transmitted over one specific link of the multiple links are removed from the transmit buffer regardless of any respective data unit acknowledgment from the recipient ML device.

2. The method of claim 1, wherein the data units transmitted over the multiple links have the same transport identifier, TID.

3. The method of claim 1, wherein the stored data units that are transmitted over one link separate from the specific link are removed from the transmit buffer based on corresponding data unit acknowledgments received from the recipient ML device.

4. The method of claim 3, wherein the data units transmitted over the specific link are low-latency data compared to the data units transmitted over the separate link.

5. The method of claim 1, wherein the removed data units are removed from the transmit buffer upon transmission over the specific link.

6. The method of claim 1, further comprising locally building an acknowledgment scoreboard upon transmitting stored data units over the specific link, wherein the acknowledgment scoreboard acknowledges the transmitted data units and is used to update the transmit buffer accordingly.

7. The method of claim 6, wherein an acknowledgment record received from the recipient ML device is modified based on the acknowledgment scoreboard.

8. The method of claim 7, wherein a bitmap of the received acknowledgment record is XORed with the acknowledgment scoreboard.

9. The method of claim 6, wherein the built acknowledgement scoreboard is locally transmitted to a buffer updating module in a block acknowledgment frame format.

10. The method of claim 1, wherein a stored data unit that is transmitted over one link separate from the specific link is removed from the transmit buffer upon receiving a respective data unit acknowledgment from the recipient ML device.

11. A communication method, at a recipient multilink, ML, device, comprising:
establishing a multilink communication session with an originator ML device to receive data over multiple links,
receiving data units over the multiple links, storing the received data units in a reordering buffer, and acknowledging the received data units to the originator ML device, and
delivering stored data units to an upper layer of the recipient ML device based on a sequence ordering of the data units,
wherein the stored data units transmitted over one specific link of the multiple links are delivered to the upper layer regardless of the sequence ordering.

12. The method of claim 11, wherein the data units received over the multiple links have the same transport identifier, TID.

13. The method of claim 11, wherein the stored data units that are received over one link separate from the specific link are delivered to the upper layer based on the sequence ordering.

14. The method of claim 13, wherein the data units received over the specific link are low-latency data compared to the data units received over the separate link.

15. The method of claim 11, wherein the stored data units that are received over the specific link are delivered to the upper layer upon reception thereof.

16. The method of claim 11, wherein the stored data units that are received over one link separate from the specific link are delivered to the upper layer depending on a sequence ordering of correctly received data units.

17. A wireless communication device comprising at least one microprocessor configured for carrying out the steps of a communication method, at an originator multilink, ML, device storing data units in a transmit buffer, comprising:
establishing a multilink communication session with a recipient ML device to transmit the stored data units over multiple links based on an acknowledgment scheme acknowledging correct reception of the data units,
transmitting the data units over the multiple links, and
removing stored data units from the transmit buffer based on corresponding data unit acknowledgments received from the recipient ML device,
wherein the stored data units transmitted over one specific link of the multiple links are removed from the transmit buffer regardless of any respective data unit acknowledgment from the recipient ML device.

18. A non-transitory computer-readable medium storing a program which, when executed by a microprocessor in a wireless device, causes the wireless device to perform the method of claim 1.
